(19) United States
(12) Patent Application Publication
(10) Pub. No.: US 2009/0285206 A1
(43) Pub. Date: Nov. 19, 2009

(54) NETWORK SYSTEM AND DATA TRANSFER METHOD

(75) Inventors: Yoshiyuki Kawauchi, Saitama-shi (JP); Hisahiro Ishida, Saitama-shi (JP); Toshiaki Arai, Saitama-shi (JP); Takashi Maki, Saitama-shi (JP); Yoshio Matsuno, Saitama-shi (JP)

Correspondence Address: DARBY & DARBY P.C., P.O. BOX 770, Church Street Station, New York, NY, 10008-0770, US

(73) Assignee: Mitsubishi Materials Corporation, Tokyo (JP)

(21) Appl. No.: 12/066,857

(22) PCT Filed: Sep. 14, 2006
(86) PCT No.: PCT/JP2006/318305

§ 371 Date: Oct. 22, 2008

(30) Foreign Application Priority Data
Sep. 14, 2005 (JP) 2005 267562

(51) Int. Cl. H04L 12/56

(52) U.S. Cl. 370/389

(57) ABSTRACT

The network system of the present invention is comprises lower segments constituted in each of a plurality of organizations, floors, offices, and an upper segment that connects the lower segments together. The network system comprises an improved L2 switch that is installed in each lower segment and has a function to transmit a frame, which is transmitted from other network devices of each lower segment to the improved L2 switch itself to a center device that is installed in upper segment; and the center device that is individually connected to the improved L2 switch and controls the data communication of the frame between the improved L2 switches. According to the present invention, a network system; wherein data communication can be performed easily between the lower segments, and an ideal data transfer system which can be prepared optionally by changing the center device characteristics when necessary, can be offered.

### CROSS-REFERENCE TO PRIOR APPLICATION

This is a U.S. National Phase Application under 35 U.S.C. §371 of International Patent Application No. PCT/JP2006/318305 filed Sep. 14, 2006, and claims the benefit of Japanese Patent Application No. 2005-267562, filed Sep. 14, 2005, both of them are incorporated by reference herein. The International Application was published in Japanese on Mar. 22, 2007 as WO 2007/032451 A1 under PCT Article 21(2).

### TECHNICAL FIELD

The present invention relates to a network system and data transfer method consisting of upper segments to integrate the data transmission between lower segments, which are separated either physically or logically, such as a plurality of organizations, floors, and offices.

### BACKGROUND OF THIS INVENTION

Due to the spread of personal computers and information household appliances (HDD (hard disk drive) recorders and the like), IP telephones, and web cameras (below, referred to as network devices), these devices are connected commonly and mutually by networks (networks corresponding to the IEEE802.3 standard) when they are used.

It is common that each network constitute one segment (below, referred to as lower segment) independently for each organization, floor, and office (for an example, refer to Japanese Patent Application, First Publication No. 2003-505934 (“JP ‘934”)).

For efficient operation, each lower segment is connected by a network (below, referred to as an upper segment) that connects each lower segment, thus configuring one network system.

The configured network system is connected by the upper segment, and a bigger network system is configured thereof.

The lower segments and the upper segment are connected by the network devices, which are composed of L2 switches or L3 switches, or L3 switches and/or NAT (Network Address Translation).

However, as shown in FIG. 13, there are advantages and disadvantages to these switches and the NAT.

Here, the setting of each switch is almost unnecessary when arranging the L2 switches, and installing them can connect networks.

However, in the network shown in JP ‘934, since it is necessary to set a unique IP (Internet Protocol) address through all segments; as shown in FIG. 15, the device IP address (below, referred to as lower IP address) in each low segment is not able to be set freely, and independent operation is not possible in the individual LAN (Local Area Network).

For example, in FIG. 15, computer A in lower segment 1 and computer D in lower segment 2 have the same IP address, but since the IP address systems of these segments are duplicated, data cannot be transmitted and received between these segments.

In addition, since the number of the network devices belonging to one segment become enormous, once communication performed for all network devices (broadcast) have occurred, heavy load will be placed on the communications.

On the other hand, when L3 switches are arranged between upper segments and lower segments, the broadcast can be divided into each lower segment, and a load of the network is reduced.

However, in order to perform communication freely between the network devices connected to different lower segments, it is necessary to assign a unique address for each network device through all segments, and only IP protocol can be used.

In addition, for an individual L3 switch, it is necessary to define (set) the communication path to each lower segment, thus operative costs of the offices increase.

Since a lower IP address can be assigned independently when a NAT is used with an L3 switch, the lower segment operative costs decrease, but a problem occurs where communication between the network devices belonging to lower segments cannot perform freely.

The present invention, in view of such circumstances, is aimed at offering a network system and data transfer method consisting of improved L2 switches as the lower segment communication devices and a center device that have functions to be described later, which problems shown in the table of FIG. 13, and offers an appropriate data transfer system by changing the characteristics of the center device when necessary.

### SUMMARY OF THE INVENTION

The network system of the present invention includes a lower segments constituted separately in such organizations, floors and offices, and an upper segment that connects the lower segments together; and the network system is characterized by having an improved L2 switch that is installed in each lower segment and a center device that is installed in higher segment, the improved L2 switch is a L2 switch having a function to transmit a frame to a center device that is installed in the upper segment; and the frame is transmitted from other network devices of each lower segment in which the improved L2 switch belonging therein to the improved L2 switch itself and the control device is individually connected to the improved L2 switch and controls the data communication of the frame between the improved L2 switches.

The network system of the present invention is characterized in that the center device includes a database in which data including a connection number of the center device corresponds to the number of the connection port of the center device to the improved L2 switch for each lower segment, a lower IP address for a network device that exists in each lower segment, and a MAC address for each network device that exists in each lower segment, are recorded as an address conversion table which is described corresponding to each network device; a communication identifying section that identifies whether the received data communication is the L2 mode data communication that should be processed in the second layer in the OSI hierarchy model, the L3 mode data communication that should be processed in the third layer in the OSI hierarchy model, or other data communication; an L2 data communication control section that controls the data communication; and an L3 data communication control section that controls the L3 mode data communication.

The network system of the present invention is characterized in that the L3 data communication control section changes the MAC addresses of the L3 mode data communication and controls L3 data communication based on the address conversion table in the L3 mode data communication; the L2 data communication control section performs rewriting of the addresses with or without change of the MAC address based on the address conversion table and controls L2 data communication in the L2 mode communication; and has more than one control section from among the two kinds of communication control sections with an optionally assigned number and an optionally assigned combination, whereby combinations can be changed at optionally assigned timing.

The network system of the present invention is characterized by having an instrument for comparing the combination of a source IP address, a source MAC address, and a connection number with those in the database; and the instrument updates the IP address, MAC address and connection number in the database when the database does not have the appropriate entry.

The network system of the present invention is characterized by including a database update section to request or carry out address resolutions for lower segments connected to a connection numbers other than the connection number that received the data which should be transmitted when it is necessary to transmit the data to the IP addresses which is not recorded in the database.

The network system of the present invention is characterized in that the center device has a database in which a connection number of the center device, corresponds to the number of the connection port to the improved L2 switch for each lower segment a lower IP address that exists in each lower segment, a MAC address for each network device that exists in each lower segment, and an identifier data such as an address which is uniquely assigned to each network device of the lower segment, are recorded as an address conversion table which is described corresponding to each network device; a communication identifying section that examines whether the received data communication is the L2 mode data communication that should be processed in the second layer, the L3 mode data communication that should be processed in the third layer, or other data communication; an L2 data communication control section that controls the data communication with the L2 mode; and an L3 data communication control section that controls the data communication with the L3 mode.

The network system of the present invention is characterized in that the L3 data communication control section controls the change of the MAC addresses and IP address of the L3 mode data communication, recalculation of check sum, and L3 data communication, based on the address conversion table in the L3 mode data communication; the L2 data communication control section performs rewriting of the addresses of the L2 mode data communication MAC addresses, with or without change of the MAC address and IP address of the L2 mode data communication, recalculation of check sum, based on the address conversion table, and controls L2 data communication; and has more than one control section from among the two kinds of communication control sections with an optionally assigned number and an optionally assigned combination, whereby combinations can be optionally changed at optionally assigned timing.

The network system of the present invention is characterized by including an instrument for comparing a source IP address, a source MAC address, and a connection number group that receives a frame with those in the database and updates the IP address, MAC address and connection number in the database when the database does not have the appropriate entry concerning of all frames or part of the frames that the center device received.

The network system of the present invention is characterized by having a database update section to request or carry out address resolutions for lower segments connected to a connection number other than the connection number that received the data which should be transmitted, to maintain upper identifiers group which is able to be used as an upper identifier of each network device to grant an upper identifier which is not used on the database at the time of update of the database when it is necessary to transmit the data to the IP addresses which is not entered into the database.

The network system of the present invention is characterized by having a hierarchical network comprising a plurality of center devices previously described, and the center devices expressed in claims which is installed on the high order of the plurality of center devices and connect the plurality of center devices together as a lower segments.

The network system of the present invention is characterized in that more than one of the aforementioned improved L2 switch and center device is emulated software.

Furthermore, the data transmission method of the present invention is a data transmission method in a network comprised of a lower segment constituted in each of a plurality of organizations, floors and offices; and an upper segment that connects the lower segments together: the method includes a process that an improved L2 switch which is installed in each lower segment, has a function to transmit frames, which are transmitted from other network devices in each lower segment in which the improved L2 switch belonging therein to the improved L2 switch itself, to a center device that is installed in the upper segment; and a process that the center device is individually connected to the improved L2 switch and controls the data communication of the frame between the improved L2 switches.

As explained above, according to the present invention, since common by improved L2 which have a function to change the destination MAC address of the transmitting frame into an MAC address of the higher segment without any detailed routing setting are arranged in each lower segment as previously mentioned, maintenance costs can be reduced by omitting the individual setting of unnecessary switches.

In addition, according to the present invention, since the same device can be used without depending on the purpose of the system, the unit price of improved L2 switches can be reduced by mass production in comparison with the conventional switches.

In addition, according to the present invention, as shown in the table of FIG. 14, a network system with few faults can be built in each system.

In addition, according to the present invention, especially, by using an upper identifier (for example, an upper IP address) that is peculiar to each device in all segments, center devices can recognize the network by the database even if there are some conflicting devices that have the same lower IP address in the corresponding lower segment, and an excellent network system can be made.

In addition, according to the present invention, a network system can be constructed using common devices whether an upper identifier (such as, upper IP address) is used or not, and a network system suited for the purpose can be changed easily constructed by changing the process flow of the center device without changing the setting of the lower segment.

### BRIEF DESCRIPTION OF THE DRAWINGS

FIG. 1 is a block diagram showing the configuration example of the network according to the first and second embodiment of the present invention.

FIG. 2 is a schematic diagram explaining the function of the center device 100 of the first embodiment in FIG. 1.

FIG. 3 is a schematic diagram explaining the function of the center device 100 of the second embodiment in FIG. 1.

FIG. 4 is a schematic diagram showing the configuration of an address conversion table recorded in database EFDB2 in FIG. 3.

FIG. 5 is a schematic diagram showing the description of each address in the header information appended to the frames.

FIG. 6 is a flow chart showing an example of operation of L2 in the first and second embodiments of the present invention.

FIG. 7 is a schematic diagram showing the description of each address in the header information appended to the frames.

FIG. 8 is a schematic diagram showing the description of each address in the header information appended to the frames.

FIG. 9 is a schematic diagram showing the configuration of an address conversion table recorded in database EFDB2 in FIG. 3.

FIG. 10 is a schematic diagram showing the description of each address in the header information appended to the frames.

FIG. 11 is a schematic diagram showing the description of each address in the header information appended to the frames.

FIG. 12 is a schematic diagram showing the configuration of an address conversion table recorded in database EFDB2 in FIG. 3.

FIG. 13 is a schematic diagram showing the description of each address in the header information appended to the frames.

FIG. 14 is a schematic diagram showing the description of each address in the header information appended to the frames.

FIG. 15 is a schematic diagram showing the description of each address in the header information appended to the frames.

### DETAILED DESCRIPTION OF THE INVENTION

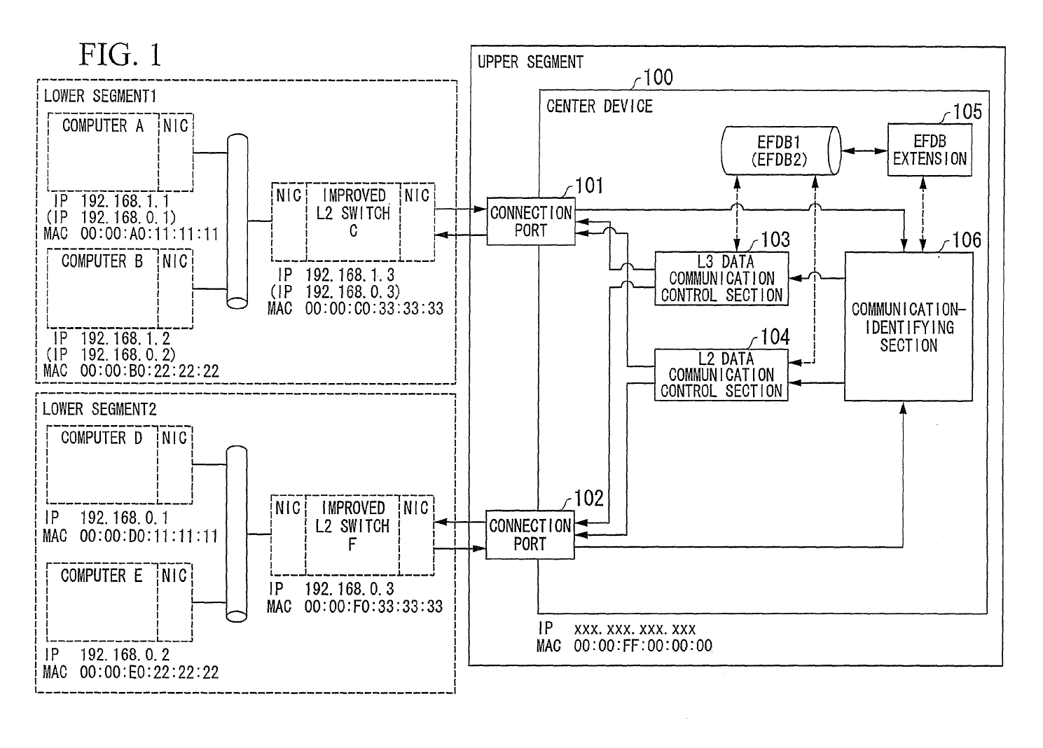

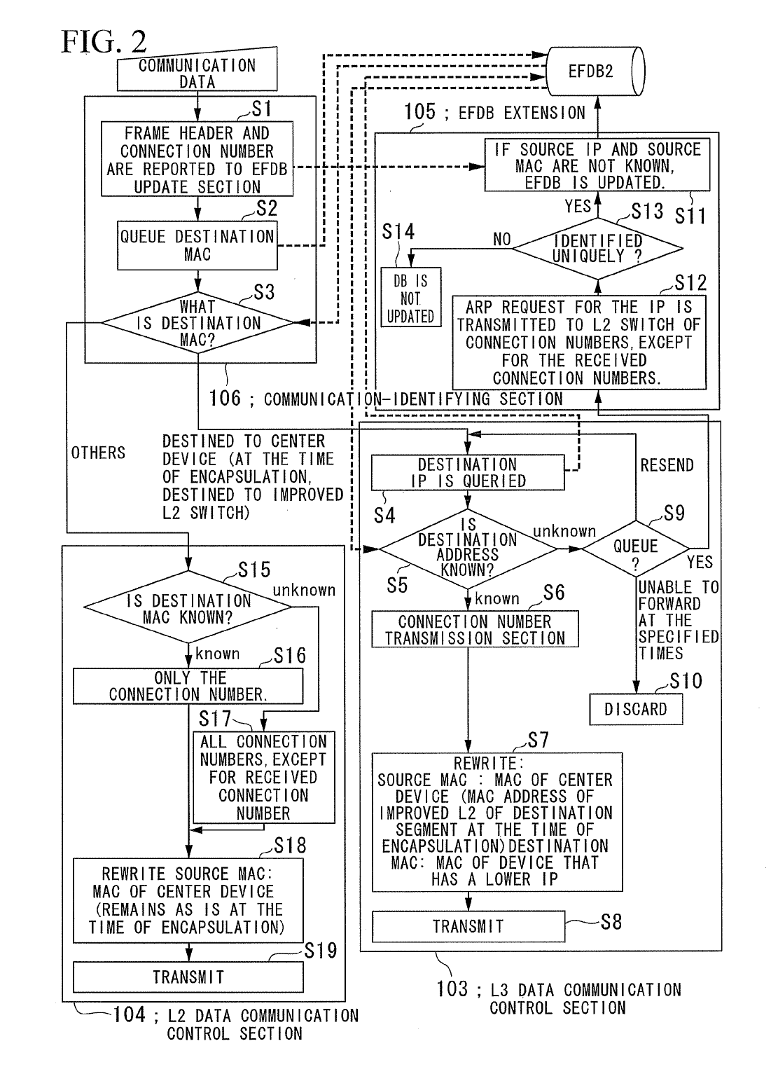

Below, a network system according to an embodiment of the present invention will be explained by referring to the drawings. FIG. 1 is a block diagram showing the configuration of the embodiment. In addition, FIG. 2 is a schematic diagram that explains the example of center device 100 in FIG. 1 in detail.

In this figure lower segments formed by a plurality of organizations, a plurality of floors, or a plurality of offices; for example, each of the lower segments 1 and lower segments 2, are connected to an upper segment by an improved L2 switch C and an improved L2 switch F respectively.

A connection port to the improved L2 switch with the center device 100 is established, and an improved L2 switch C of lower segment 1 is connected to connection port 101 through an NIC (Network Interface Card), and an improved L2 switch F of lower segment 2 is connected to connection port 102 in the same manner through an NIC.

In lower segment 1, as connected instruments, computer A and computer B are each connected to improved L2 switch C through NIC.

In the same manner, in lower segment 2, as connected instruments, computer D and computer E are each connected to improved L2 switch F through NIC.

The improved L2 switch of the present invention is arranged in each lower segment, differs from a normal L2 switch (it discards frames to the lower segment and to itself, and forwards all the other frames to the upper segment), and transmit frames addressed to the improved L2 switch itself, to the upper segment (in this embodiment, the center device) after changing the source MAC address to own MAC address, the destination MAC address to MAC address of to the center device, respectively, if necessary.

In addition, the improved L2 switch of the present invention is characterized in that it is not necessary to set a transfer routing individually, as same as the conventional L2 switch or different from the conventional L3 switch.

Center device 100 has more than one database EFDB1, communication identifying section 106, L2 data communication control section 104, and L3 data communication control section 103 with optional combinations.

An EFDB extension 105 may be added to the center device 100.

In other words, the center device 100 has more than one control section from among the two kinds of communication control sections; L2 data communication control section 104 and L3 data communication control section 103, with an optionally assigned number and an optionally assigned combination, whereby combinations can be optionally changed anytime.

In addition, it will be mentioned later, but the database EFDB1 is not used when the database EFDB2 is used as a database for searching MAC addresses and IP address

Database EFDB1, for example, in the stage where the center device 100 is connected to the improved L2 switch C, transmits the improved L2 switch C lower IP address and MAC address for the center device 100 from the improved L2 switch C, and they can be written in correspondence with the connection number of the connected connection port.

In addition, the information of the improved L2 switch connected to the center device 100 corresponds with the connection number and can be controlled to be written in database EFDB1 in advance.

Next, an example of the operation of the network system according to the embodiment of the present invention will be explained by referring to FIG. 1 and FIG. 2.

In this FIG. 1, in the explanation of this first embodiment, “192.168.1.1”, “192.168.1.2”, and “192.168.1.3”, entered in the lower section of each network device, are used for the lower IP addresses of lower computer A computer B and the improved L2 switch C in lower segment 1 respectively.

Communication identifying section 106 acquires the destination MAC address of a frame that transmits data received from each improved L2 switch, and indicates the frame header that includes the destination MAC address and a connection number for EFDB update section 105 (step S1).

Next, communication identifying section 106 searches whether there the destination MAC address in MAC address pre-recorded in database EFDB1 (step S2).

And, communication identifying section 106, as a result of the search, identifies (detects) that this frame data communication is L3 communication when it is detected that the destination MAC address conforms to an MAC address of center device 100 (and using a communications infrastructure such as VPN (Virtual Private Network) by encapsulating the data communication between an improved L2 switch and center device, that the destination MAC address to the MAC address of a corresponding improved L2 switch), and this frame is forwarded to L3 communication control section 103 (step S3).

Here, the network device that transmits a frames adds necessary header information to communication between improved L2 switch C and center device 100; in other words, by changing the destination MAC address into the MAC address of the improved L2 switch, a communication route can be connected by using an encapsulation, and the network device can transmit frames without changing the frame in itself to be transmitted.

In other words, communication identifying section 106 detects the destination MAC address of the frame which has been forwarded, and examines whether this destination MAC address is an addressed of center device 101 or an address of improved L2 switch C.

Then, when communication identifying section 106 detects that a frame is send to the improved L2 switch C, it identifies that if the frame is has been found encapsulated. When, when it detects that the frame is sent to the center device 100 is addressed, it identifies that the frame is not encapsulated, and decides that the frame should be handled in it is necessary to perform the movement of the L3 mode and forwards a frame to L3 communication control section 103.

On the other hand, when communication-identifying section 106 detects the destination MAC address of the frame is consistent is accorded with one of MAC addresses of other devices or when the MAC address is it has not found been detected in database FEDB1 (an unknown MAC address) it decides determines (detects) that the frame should be handled in the it is L2 mode communication, and forwards the this frame to L2 communication control section 104 (step S3).

Here, the L2 mode data communication means that is the frame has the format form data that should be processed at the second layer in the OSI hierarchy model, and the L3 mode data communication means that the frame has the format that should be processed at the third layer in the OSI hierarchy model and shows the frame form data, which should be processed.

Next, L3 communication control section 103 acquires the destination lower IP address from the received frame of data communication frame, and examines searches to see if whether or not there is this destination lower IP address in the lower IP address pre-recorded in database EFDB1 (step S4, S5).

And, L3 communication control section 103, when a lower IP address in consistent unison with the destination lower rank IP address has been detected in the lower IP address pre-recorded in database EFDB1; in other words, when this destination lower rank IP address has already been registered, extracts the MAC address of the improved L2 switch from database EFDB1 consistent from a connection number (step S6).

Furthermore And, L3 communication control section 103 changes the source MAC address to the an improved L2 switch MAC address of the improved L2 switch which belongs to the same lower segment that; the lower segment belonging to the network device having the that has a lower IP address in the said source MAC address, changes the to destination MAC address to in the said MAC address of the network device, and transmits the a frame to for this improved L2 switch (step S7, S8).

On the other hand, L3 communication control section 103 stores the data communication frame in a queue when there is not database EFDB1 is not able to detect a lower IP address corresponding to the a destination lower IP address in database EFDB1, and notices transmits the destination lower IP address of this frame consecutively to EFDB extension 105 (step S9).

In addition, L3 communication control section 103 discards destroys this frame when it exceeds the specified count, wherein the same frame has been set, and has detected that the same a data communication frame has been stored in queue more times than threshold (step S10).

And, L3 communication control section 103 checks confirms database EFDB1 after a fixed time. When it finds that the previously mentioned destination lower IP address has been stored in the database, and it forwards the frame of the data communication concerned to for a corresponding supporting improved L2 switch when the previously mentioned destination lower IP address has been detected and after having changed both performed the renewal of each similar MAC address just same as it does when the lower IP address concerned has been detected to be registered (step S7, 8).

In addition, after EFDB extension 105 examines detects whether there is a source lower IP address of with a received data communication frame among corresponding to the lower IP address registered in with database EFDB1, the extension extract a lower IP address and MAC address from the a frame when it is not registered, and allows it to be recorded and registers them registered with a connection number into and database EFDB1, when the source lower IP address is not registered (step S11).

In addition, EFDB extension 105, when a lower IP address has been received from L3 communication control section 103, performs communication aiming at aimed for Address Resolution to an improved L2 switch connected to a connection number other than the destination when a lower IP address has been received from L3 communication control section 103 (step S12), and when a reply packet from any of the improved L2 switches is received by any of the improved L2 switches, EFDB extension 105 detects that they are being handled one-on-one, in other words, EFDB extension 105 examines detects whether a network device can be distinguished uniquely uniformly (step S13), cancels it if it is an IP address duplicating in a plurality of network devices (step S14), and registers it in if it can be distinguished uniquely, then it is registered with database EFDB1 if it can be distinguished uniquely (step S11).

L2 communication control section 104 acquires a destination MAC address from the received data communication received, and searches whether there is one that corresponds to a MAC address pre-recorded in database EFDB1 (step S15).

And, L2 communication control section 104 transmits the a frame to for the improved L2 switch connected to a searched connection number concerned when the MAC address concerned has already been registered with database EFDB1 (step S16).

On the other hand, L2 communication control section 104 transmits the a data communication frame to for all improved L2 switches other than one which has the source MAC address when the corresponding an MAC address that corresponds to database EFDB1 is not registered in database EFDB1 (step S17).

Then, L2 communication control section 104 changes the source MAC address into in the MAC address of center device 100, and transmits a frame without changing the destination MAC address (step S18, S19).

Next, a network system according to another embodiment of the present invention will be explained by referring to FIG. 1 and FIG. 3.

The network system of the second embodiment, unlike the first embodiment, uses database EFDB2 wherein an upper a higher IP address has been added to database EFDB1 as a database for MAC address searches.

In addition, FIG. 3 is a schematic diagram to explain the operation movement of the center device 100 in FIG. 1 in detail.

In this FIG. 1, in the explanation of this embodiment, each of the lower IP addresses of lower computer A in segment 1, computer B and the improved L2 switch C use “192.168.0.1”, “192.168.0.2”, and “192.168.0.3” entered in the ( ) lower section of each network device are used as the lower IP addresses of lower computer A, computer B and the improved L2 switch C in segment 1 respectively.

Accordingly On this account, in this embodiment, center device 100 works to change renew the source IP address to an upper in a higher identifier of the source network device, and the destination IP address to in a lower IP address of the destination device, respectively.

As the only requirement of this upper is to be able to specify the network device of the lower segment, This higher identifier uses an IPv6 address can be used as an upper a higher IP address because it should be the identification information that the network device of the lower segment can specify, and any value that can uniquely identify the network device, such as the combination of if the connection number of the connection port and combinations with the lower IP addresses, can be used as an upper identifier are the identification information that each network device can detect uniformly, any value is acceptable.

In the following explanation, an upper a higher IP address is used as the upper higher identifier.

The same reference numerals as the previous embodiment are referred by the same symbols to in regards to configurations, which are similar to the first embodiment, and different points will be explained.

After EFDB extension 105 examines detects whether there is a the transmission source lower IP address of the received data communication frame among corresponds to the lower IP address registered in with database EFDB2, and when it is not registered, the extension extracts the lower IP address and MAC address from the frame when it is not registered, and records and registers them with a the connection number and the appropriate upper higher IP address (chosen among accumulated unused upper higher addresses mentioned later) in database EFDB2.

Thereby, EFDB extension 105 performs communication aiming at aimed for Address Resolution to an improved L3 switch connected to a connection number other than the destination when a lower IP address from L3 communication control section 103 is received.

L2 communication control section 104 acquires a destination MAC address from the received data communication, and searches to see whether there is one that it corresponds to an MAC address pre-recorded in database EFDB21.

And, L2 communication control section 104 transmits a frame to for the improved L2 switch connected to the searched connection number concerned, when the corresponding MAC address concerned has already been registered in database EFDB2.

On the other hand, when the corresponding MAC address is not registered in database EFDB2, L2 communication control section 104, transmits a frame to for all improved L2 switches, which MAC address differs from the except for the transmission source MAC address.

Next, the movement example of the operation of the network system will be explained according to this embodiment of the present invention by referring to FIG. 1 and FIG. 3. In FIG. 3, the same step number is referred in the step that performs the same process as FIG. 2 of the other embodiment. Only the different points will be explained. The major big difference is step S20 which is, the point inserted between steps S6 and S7 to use the upper higher IP address.

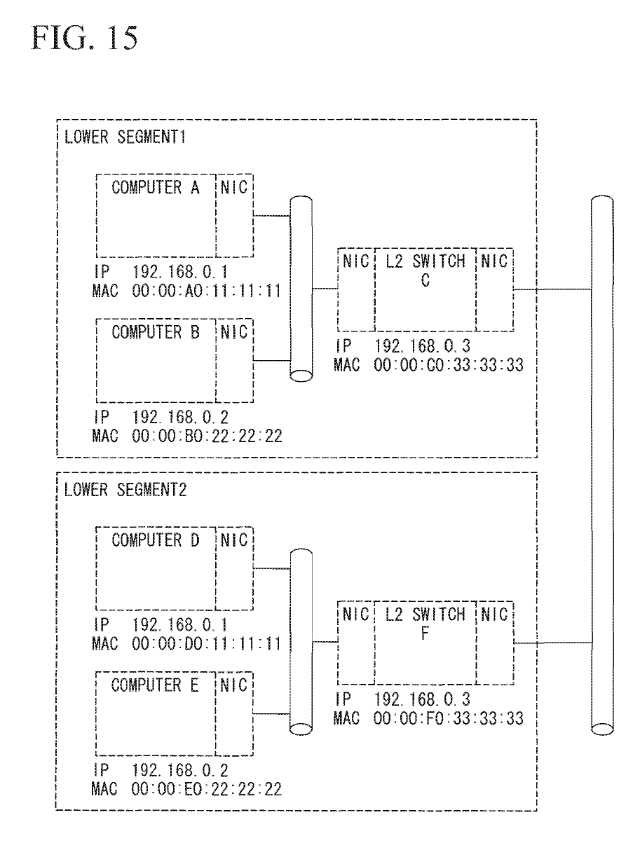

As previously mentioned, in the conventional network system shown in FIG. 15, in which ordinary L3 switches, L2 switches, or the like are used, when cComputer A in lower segment 1, transmits to computer D in other lower segment 2, since the due to the overlapping address scopes realms of lower segment 1 and lower segment 2 overlap, when connecting via ordinary L3 switches, L2 switches, or the like, the destination IP address will appear to be the same as itself, so transmission will not be possible.

Therefore, in the present invention, in the data communication method shown below, frames are transmitted and received between each network device.

In this embodiment, the operation movement will be explained for when data communication for transmitting a frame is performed from computer A of lower segment 1 sends frames for data communication to computer D of lower segment 2 will be explained.

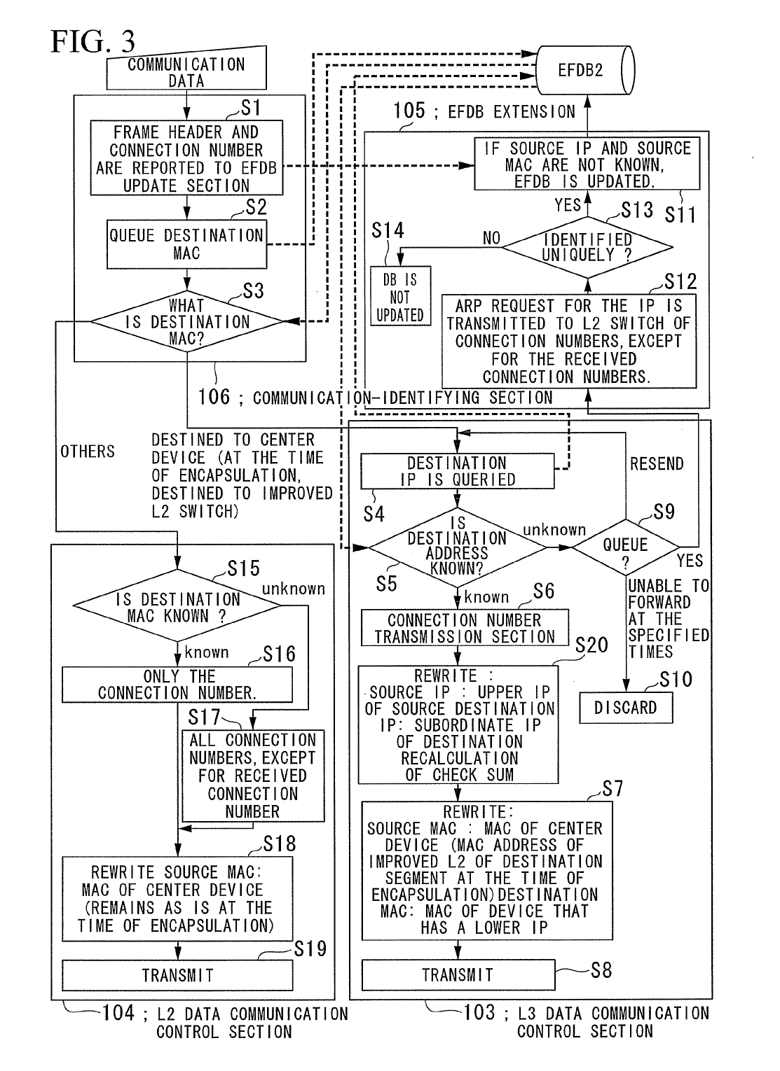

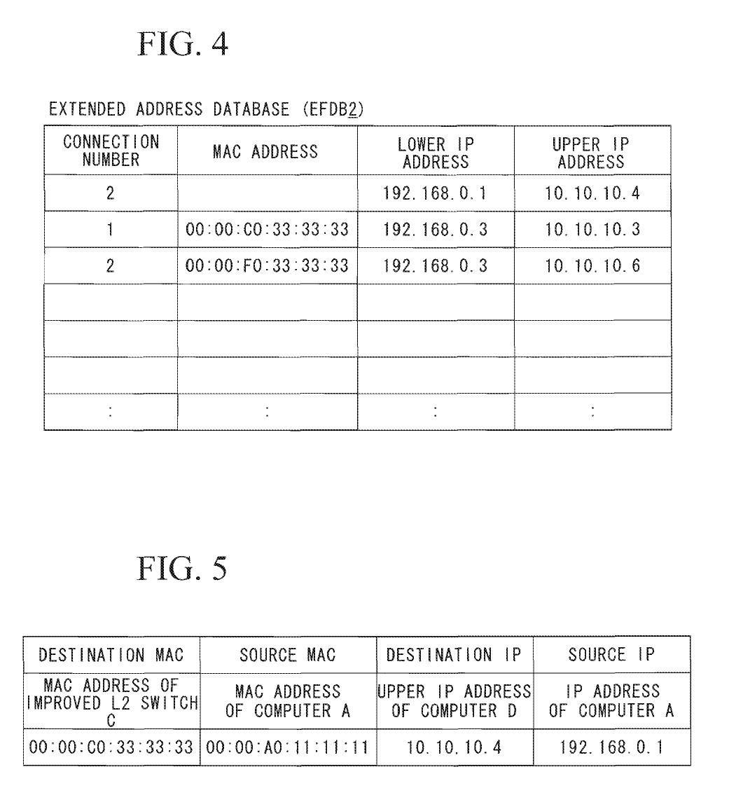

Here, as a prerequisite of the data transmission movement, in database EFDB2, an address conversion table, which includes at least the data of the network device of the whole network shown in FIG. 4, is prepared in database EFDB2 for to perform communications.

Then, in computer A is informed in advance that, the upper higher IP address of computer D prepared in advance is “10.10.10.4”, and computer A can communicates with computer D through the prerequisite is that one is aware that all that is needed is to access this address.

In addition, improved L2 switch C transmits the its own MAC address and an IP address to center device 100 beforehand, and registers itself in database EFDB2.

The upper higher IP address used here ideally prepares for the number corresponding to all computers of all lower segments in the whole network.

In addition, the prepared upper higher IP address does not use the value of the address to duplicate with another.

In addition, as the upper a higher IP address, the combination of the lower IP address and the connection terminal connection number of the connection port may be used for the numerical value that can distinguish the network device uniquely uniformly.

When cComputer A communicates with computer D, computer A sends transmits a frame with an address shown in FIG. 5 as header information to improved L2 switch C in FIG. 5 as header information when it is communicated for computer D.

Here, computer A can estimate that if performed, it can determine the destination MAC address of for the improved L2 switch C can be used as a destination MAC address by from computer A or the routing table within computer A itself or within; wherein the other routers which are not illustrated are maintained. Alternatively, Or other routers not illustrated transfer it, and the frame mentioned above arrives at the improved L2 switch C. When other routers have transferred it, these other routers transfers the forward the transmission source MAC address as its own transferred MAC address of other routers itself.

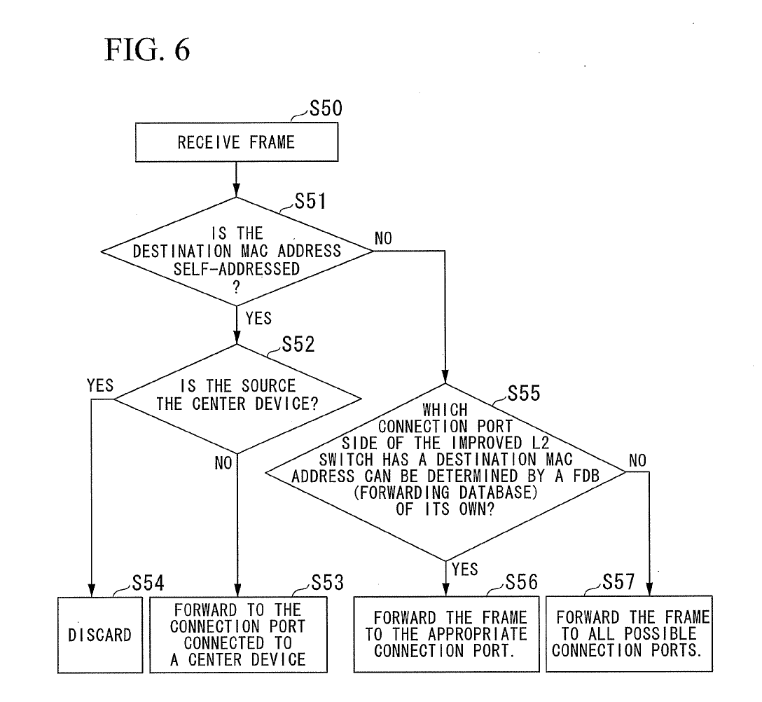

Here, when a frame having the header information of FIG. 5 is received, the improved L2 switch performs processing for the frame according to the flow chart shown in FIG. 6 (the improved L2 switch in the above embodiment performs similar operation movement in this processing).

When a frame is received (step S50), the improved L2 switch examines performs a detection to see if whether or not it is its destination own MAC address is consistent with its own MAC address (step S51). If it is self-addressed, the process is switched over to step S52, and if it is not self-addressed, the process is switched over to step S55.

Next, when the that destination has been detected to be as its own, the improved L2 switch examines detects whether the a transmission source MAC address of this frame is consistent with one of belongs to center device 100 (step S52). When the frame is sent from transmission source detects that it is center device 100, it discards destroys this frame (step S54), and when the transmission source detects that it is not sent from center device 100, it forwards the a frame to for the connection port connected to connection terminal 101 of center device 100 (step S53).

On the other hand, since the improved L2 switch is a network device in lower segment 1, when a destination MAC address is found to be not its own in step S51, it examines it detects whether which connection port side of the improved L2 switch has a destination MAC address by a FDB (Forwarding Database) of its own (step S55) when a destination MAC address that is not its own is detected in step S51, and it transfers the forwards a frame to (step S56) for a corresponding connection port when it has been detected (step S56); and on the other hand, it transfers to for all possible connection ports when it is not detected by FDB (step S57).

Returning to FIG. 1, since the destination of the frame is the improved L2 switch itself, improved L2 switch C transfers the forwards an input frame to for center device 100.

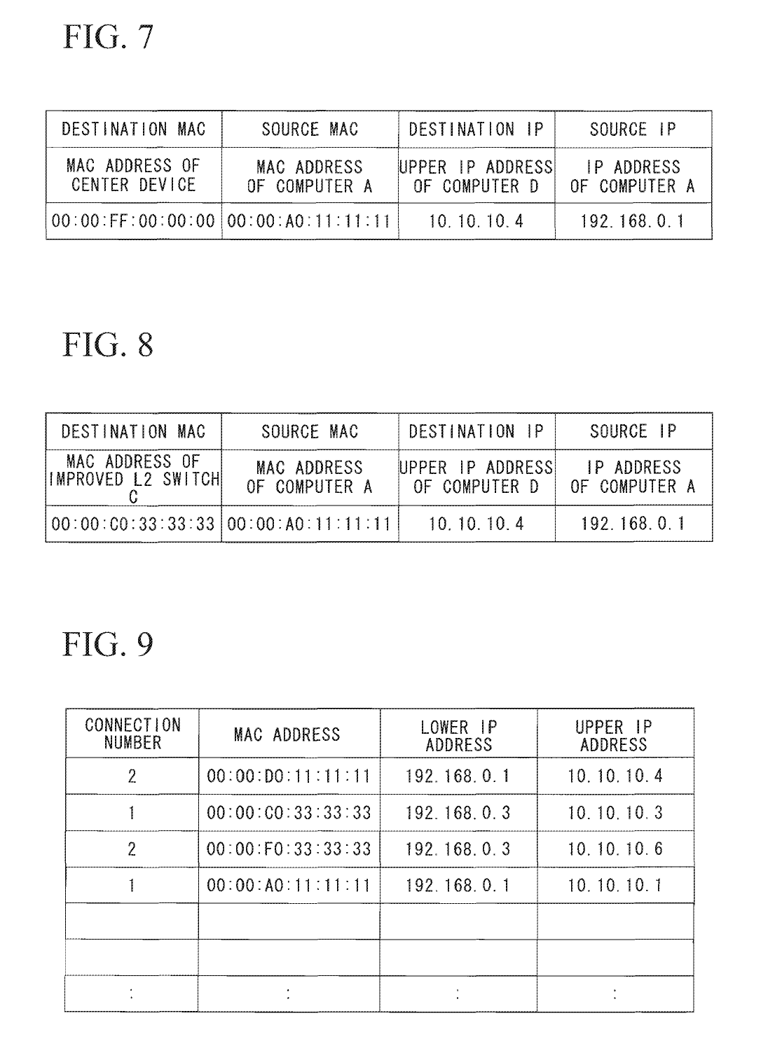

Here, when communicating directly, the frame at the time of transfer has header information, which possesses the address shown in FIG. 7. Alternatively, or header information shown in FIG. 8, and the frame are encapsulated into by another MAC frame; in other words, when not the MAC address of the improved L2 switch C but one of the is forwarded as is to center device 100 is settled as the destination MAC address, the frame is transmitted to the of the destination, not the MAC address of center device 100 as is stands.

When the a frame is inputted from center device 100, communication-identifying section 106 acquires a frame header and a connection number, which include the destination MAC address and a connection number of the frame received from each improved L2 switch, and indicates the destination MAC address to for EFDB update section 105 (step S1).

Next, communication identifying section 106 examines whether there is searches the presence to conform to the destination MAC address in the MAC address pre-recorded in database EFDB2 (step S2).

And, in step S3, communication-identifying section 106 performs as same as movement like the above embodiment in step S3, and a destination MAC address outputs a frame to L2 data communication control section 104 in the case of unknown destination MAC address others. The following processing from step S15 to step S19 is similar to the other embodiment.

In addition, communication-identifying section 106 detects the destination MAC address of the frame which has been forwarded, and examines detects whether this destination MAC address is addressed to center device 101 or whether it is addressed to the improved L2 switch C.

Then, when communication identifying section 106 detects that a frame is addressed to improved L2 switch C, it decides that the frame has been encapsulated, and when it detects that it is addressed to center device 100, the frame has is not been encapsulated, and decides that it is necessary to perform the L3 mode operation movement (step S3).

In addition, in step S1, EFDB update section 105 learns that IP address of computer A (connection port 101, network device, segment corresponding to improved L2 switch C which is connected to connection port 101, connection number 1; segment) is IP address “192.168.0.1” and is the MAC address “00:00:A0:11:11:11” from a transmission source IP address and a transmission source MAC address transmitted from communication-identifying section 106 in step 1, and registers database EFDB2 and updates it.

Then, if necessary, EFDB update section 105 acquires an upper a higher IP address to add it to computer A from the address pool where unused upper higher rank IP addresses are accumulated when necessary.

When L3 data communication control section 103 searches the forwarding address IP address of the frame which arrived in database EFDB2, and by detecting the address when it detects that it corresponds to the upper higher IP address of computer D “10.10.10.4” it detects connection port 102; the network device which has of the lower IP address “192.168.0.1” corresponding to improved L2 switch F which is connected to connection port 102 of connection number 2; in other words, it detects that it is computer D based on from an address conversion table in FIG. 4 (step S4, S5).

On the other hand, when an MAC address of computer D is not found in database EFDB2, EFDB update section 105 sends transmits an ARP packet in order to search for MAC address to searches for the improved L2 switch D connected to connection port 102 of connection number 2 when an MAC address of computer D is not searched by database EFDB2, and examines whether a MAC address added to the machine of the lower IP address “192.168.0.1” in the LAN of lower segment 2 performs a detection to detect if whether it is “00:00:D0:11:11:11” (step S9, S12).

And, when EFDB update section 105 inputs a reply packet for the above ARP packet from improved L2 switch D, and lower IP address “192.168.0.1” and MAC address “00:00:D0:11:11:11” can be identified uniquely decided uniformly; in other words, it updates database EFDB2 when they correspond one 1 to one; 1, the section updates database EFDB2 and registers MAC addresses like in the lowest frames in the table of FIG. 7 (step S13, S11).

In addition, this frame is discarded destroyed when lower IP address “192.168.0.1” and MAC address “00:00:D0:11:11:11” cannot be uniquely identified decided uniformly (step S13, S14).

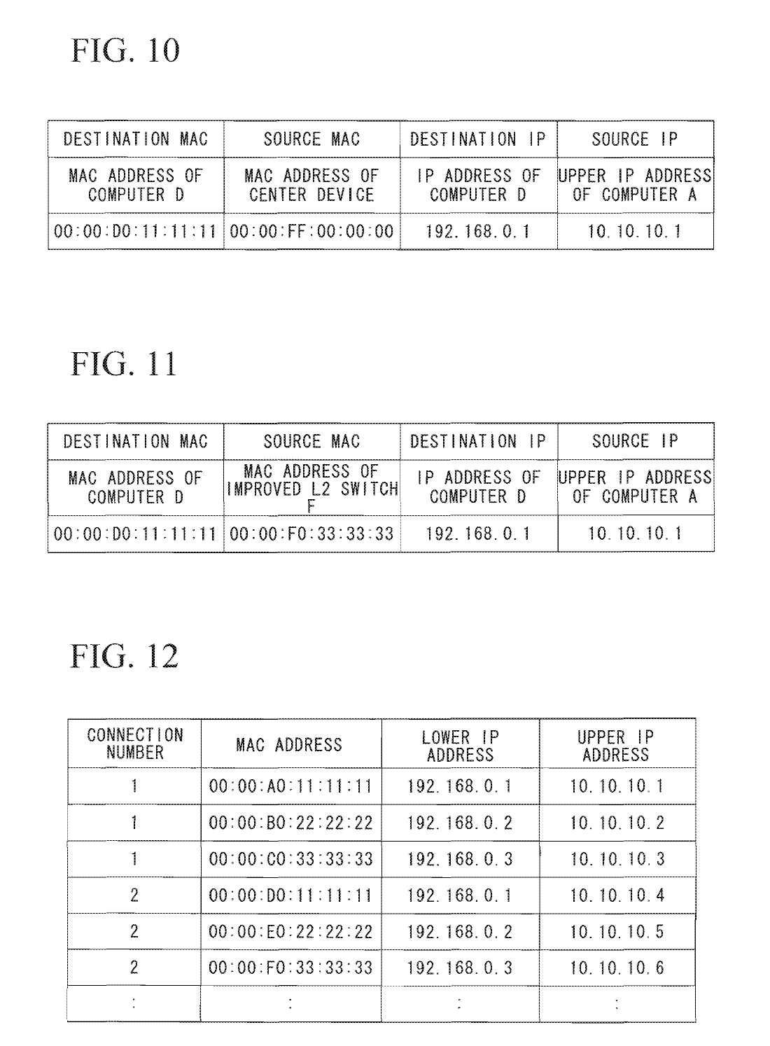

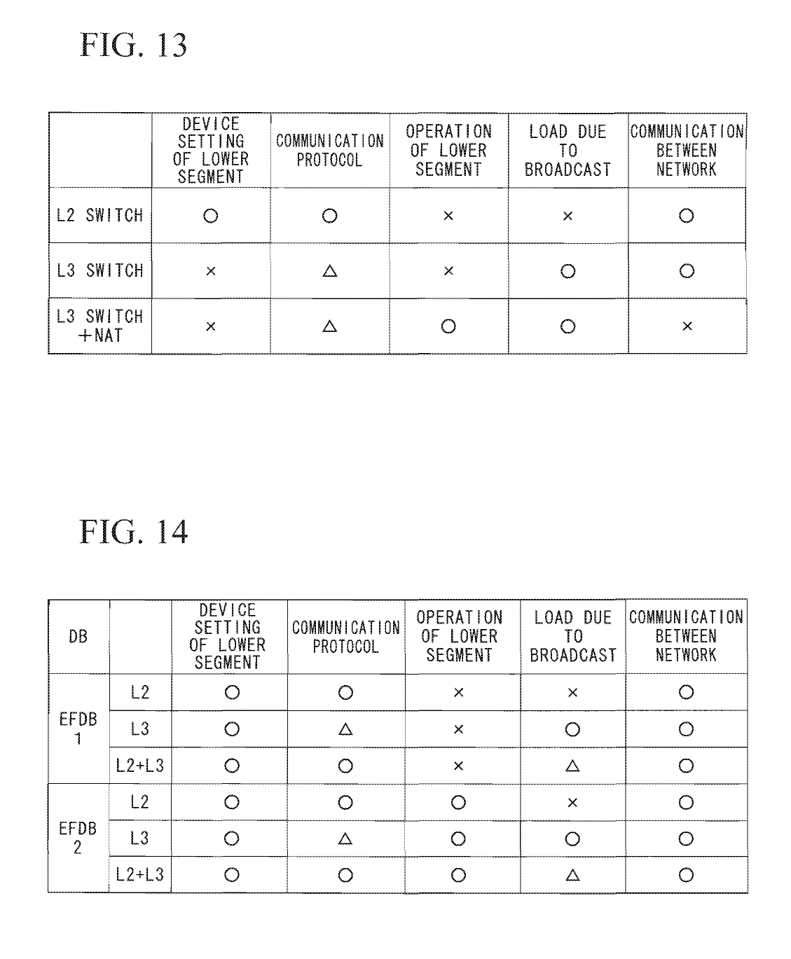

Next, L3 data communication control section 103 receives (inputs) a frame having the header information of the address shown in FIG. 7 or FIG. 8, and when it determines that the frame it should be transferred in the by an L3 mode, the section rewrites the frame is rewritten like the addresses in FIG. 10 and FIG. 11, and sends transfers it to for the improved L2 switch F from connection port 102 of connection number 2 (step S6, S20, S7, S8).

In other words, L3 data communication control section 103, as shown in FIG. 10 and FIG. 11, changes a destination IP address from an upper IP address of computer D to in a lower IP address of computer D from a higher IP address of computer D, changes a transmission source IP address from the lower in a higher IP address of computer A to the upper from a lower IP address of computer A, and recalculates performs the recalculation of the check sum of the frame (step S20).

In addition, when L3 data communication control section 103, as in FIG. 7, the destination MAC address is the MAC address of center device 100, and when a frame has not been encapsulated as in FIG. 7, L3 data communication control section 103 changes the source MAC address into the MAC address of center device 100 as shown in FIG. 10, the transmission source MAC address is the MAC address of center device 100, and when a frame has been encapsulated, the section changes the source MAC address to the MAC address of the improved L2 switch F as show in FIG. 11, transmission source MAC address is the MAC address of the improved L2 switch F (step S7, this is similar to the first embodiment).

In addition, EFDB update section 105, as shown in FIG. 12, in the transfer process of frames according to each process previously mentioned, when correspondence with an IP address and the MAC address of the network device has been newly detected, EFDB update section 105 registers these the corresponding information and updates is pre-recorded and additionally registered in database EFDB2 sequentially.

In addition, a program for carrying out the function of the improved L2 switch and a function of the center device in FIG. 1 may be recorded in recording mediums which can be read by with computers reading capabilities and it is possible to may perform the transfer process disposal of frames for by having it read the program recorded to this recording medium in a computing system to read and to execute the recorded program. In addition, “a computing system” mentioned here includes hardware, such as OS or peripheral devices. In addition, “a computing system” includes the WWW system equipped with homepage offering environments (or an environmental indication). In addition, “a recording medium that can be read by a computer” is a storage device, such as flexible disks, MO disks, ROMs, portable mediums, such as CD-ROMs, and hard disks built-in to computing systems. Moreover, it also includes those in which “a recording medium that can be read by a computer” maintains program for a uniform time program like a (RAM) volatile memory of a computing system inside which becomes a server and a client when a program has been transmitted through computer networks such as the internet and/or telecommunications lines, such as phone lines.

In addition, the aforementioned program may be transmitted from the computing system where this program is stored to storage devices through a transmission medium, or it may be transmitted to other computing systems by transmission wave with a transmission medium. Here, “A transmission medium” that transmits a program is a medium which has functions to transmit information like networks, such as the internet (communications network) and/or telecommunication lines (communication line), such as phone lines. Furthermore, it may be a computing system that can employ previously mentioned functions by combinations with pre-recorded programs, a so-called differential file (different programs).

As explained above, according to the present invention, a network system and a data transmission method, where an ideal system of the data transmission can be prepared optionally, can be offered.

1. A network system comprising:
a lower segment constituted in each of a plurality of organizations, floors, or offices,
an upper segment that connects the lower segments together; and
an improved L2 switch that is a L2 switch that is installed in each lower segment and transmits a frame which is transmitted to itself from other network devices of the lower segment in which the improved L2 switch itself belonging therein to a center device that is installed in the upper segment;
wherein the center device is individually connected to the improved L2 switch and controls the data communication of the frame between the improved L2 switches.

2. A network system according to claim 1, wherein the center device comprises
a database in which data including a connection number corresponds to the number of the connection port of the center device to improved L2 switch for each lower segment, a lower IP address for a network device that exists in each lower segment, and a MAC address for each network device that exists in each lower segment, are recorded as an address conversion table which is described corresponding to each network device;
a communication identifying section that identifies whether the received data communication is a L2 mode data communication that should be processed in a second layer in an OSI hierarchy model, a L3 mode data communication that should be processed in a third layer in the OSI hierarchy model, or other data communication;
an L2 data communication control section that controls the data communication with the L2 mode; and
an L3 data communication control section that controls the data communication with the L3 mode.

3. A network system according to claim 2, wherein the L3 data communication control section changes the MAC addresses of the L3 mode data communication and controls L3 data communication based on the address conversion table; the L2 data communication control section performs rewriting of the addresses with or without change of the MAC address of the L2 data communication based on the address conversion table, and controls L2 data communication; and has more than one control section among the two kinds of communication control sections with an optionally assigned number and an optionally assigned combination, whereby combinations can be changed optionally assigned timing.

4. A network system according to claim 1, further comprising an instrument for comparing a combination of a source IP address, a source MAC address, and a connection number of the received frame with the database; and for updating the database that describes the IP address, MAC address and connection number in the database when the database does not have an entry, concerning of all frames or part of the frames received by the center device.

5. A network system according to claim 1, further comprising a database update section to request or carry out address resolutions for lower segments connected to connection number other than the connection number that received the data that should be transmitted when it is necessary to transmit the data to the IP addresses which is not recorded in the database.

6. A network system comprising:
lower segments constituted in each of a plurality of organizations, floors, or offices:
an upper segment that connects the lower segments together;
at least one of an improved L2 switch, a L2 switch, or a L3 switch (hereinafter called lower switch), which is installed in each lower segment;
by a center device installed in the upper segment, connected to the lower switch, and controlling frames for data communication among the switches; and
a database in which a connection number corresponds to the number of the center device connection port with lower switch, a lower IP address that is an IP address for a network device that exists in each lower segment, a MAC address for each network device that exists in each lower segment, and an identifier data such as each IP address which is uniquely assigned to each network device of the lower segment, are recorded as an address conversion table which is described corresponding to each network device;
a communication identifying section that identifies whether the received data communication is the L2 mode data communication, the L3 mode data communication, or other data communication;
an L2 data communication control section that controls the data communication with the L2 mode; and
an L3 data communication control section that controls the data communication with the L3 mode.

7. A network system according to claim 6, wherein the L3 data communication control section controls a change of the MAC addresses of the L3 mode data communication, recalculation of check sum, and L3 data communication, based on the address conversion table;
wherein the L2 data communication control section performs rewriting of the addresses of the L2 mode data communication with or without change of the MAC address of the L2 data communication, based on the address conversion table, and controls L2 data communication; and more than one control section among the two kinds of communication control sections with an optionally assigned number more than one and an optionally assigned combination, whereby combinations can be randomly changed optionally assigned timing anytime.

8. A network system according to claim 1, further comprising a database updating instrument for comparing a source IP address, a source MAC address, and a connection number of the received frame with the database in regards to all or part of the frame received by the center device; and the instrument describes the IP address, MAC address and connection number in the database when the database does not have an entry.

9. A network system according to claim 1, further comprising a database update section to request or carry out address resolutions for lower segments connected to a connection number other than the connection number that received the data which should be transmitted, to have upper identifiers group which are able to be used as the upper identifier of the network device, and to grant the higher identifier which is not used in un-updated database at the time of update of the database when it is necessary to transmit the data to the IP addresses which is not recorded in the database.

10. A network system wherein a plurality of center devices according to claim 1 are installed, a plurality of center devices according to claim 1 that connect the plurality of center devices together as a lower segment are installed in the top of the plurality of center devices; and a hierarchical network in which the plurality of center devices are connected together is constructed.

11. A network system wherein more than one interval between the lower switch and center device according to claim 1 is connected with encapsulation technique so as to transmit a frame without changing the frame to be transmitted itself by adding header information which is necessary to communication between the lower switch and center device.

12. A network system wherein more than one of the lower and center device according to claim 1 is run by emulation using software.

13. A data transmission method in a network comprising:
a lower segment constituted in each of a plurality of organizations, floors, or offices; and
an upper segment that connects the lower segments together: and the method comprising a process that the lower switch has a function from other network devices of the lower segment in which the lower switch belonging therein to the lower switch itself to a center device that is installed in upper segment; and a process that the center device is individually connected to the lower switch and controls the data communication of the frame between the lower switches.
